(19) United States
(12) Patent Application Publication
(10) Pub. No.: US 2026/0186198 A1
(43) Pub. Date: Jul. 2, 2026

(54) BACKLIGHT SOURCE AND DISPLAY DEVICE

(71) Applicants: Chengdu BOE Optoelectronics Technology Co., Ltd., Chengdu, Sichuan (CN); BOE Technology Group Co., Ltd., Beijing (CN)

(72) Inventors: Xingyu LI, Beijing (CN); Yuangang ZHU, Beijing (CN); Tianma LI, Beijing (CN); Liang LI, Beijing (CN); Tao XI, Beijing (CN)

(21) Appl. No.: 18/729,934

(22) PCT Filed: May 29, 2023
(86) PCT No.: PCT/CN2023/096917

§ 371 Date: Jul. 18, 2024

(30) Foreign Application Priority Data
May 30, 2022 (CN) 202210597869.3

(51) Int. Cl. F21V 8/00

(52) U.S. Cl. CPC G02B 6/0088; G02B 6/0066

(57) ABSTRACT

Provided is a backlight source. The backlight source includes: a back plate, comprising a bottom plate, a first sidewall perpendicular to a first surface of the bottom plate and connected to the bottom plate, and a plurality of second sidewalls perpendicular to the first surface and connected to the bottom plate; a light guide plate, disposed on the first surface; a light source, disposed on the first surface, wherein at least a portion of the light source is disposed between the first sidewall and the light guide plate; and a plurality of limit structures, configured to secure the light guide plate, wherein the limit structure is abutted against the third sidewall, and the limit structure is connected to the second sidewall opposite to the third sidewall with which the limit structure is contacted.

### CROSS-REFERENCE TO RELATED APPLICATION

This application is a U.S. national phase application based on PCT/CN2023/096917, filed on May 29, 2023, which claims priority to Chinese patent Application No. 202210597869.3, filed on May 30, 2022 and entitled “DISPLAY MODULE AND DISPLAY APPARATUS”, the contents of which are incorporated herein by reference in their entireties.

### TECHNICAL FIELD

The present disclosure related the field of display technology, and in particular to a backlight source and a display device.

### BACKGROUND

In the relater art, the backlight source includes a light guide plate, a light source and a back plate. The light guide plate and the light source are secured in the back plate.

### SUMMARY

Embodiments of the present disclosure provide a backlight source and a display device.

According to some embodiments of the present disclosure, a backlight source is provided. The backlight source includes: a back plate, including a bottom plate, a first sidewall perpendicular to a first surface of the bottom plate and connected to the bottom plate, and a plurality of second sidewalls perpendicular to the first surface and connected to the bottom plate; a light guide plate, disposed on the first surface, including third sidewalls opposite to and parallel to the plurality of second sidewalls; a light source, disposed on the first surface, and at least a portion of the light source being disposed between the first sidewall and the light guide plate; and a plurality of limit structures, configured to secure the light guide plate, wherein the limit structure is disposed on a side, close to the second sidewall opposite to the third sidewall, of the third sidewall and is abutted against the third sidewall, and the limit structure is connected to the second sidewall opposite to the third sidewall with which the limit structure is contacted.

In some embodiments, the limit structure includes: an abutment portion attached to the third sidewall; and a deformation portion connected to the abutment portion, configured to be deformed to cause the abutment portion to be abutted against the third sidewall.

In some embodiments, the deformation portion includes a connection portion, a first support portion, and a carrier portion. The connection portion is connected to the abutment portion, wherein an orthographic projection of the connection portion on the first surface is axisymmetric about an orthographic projection of the abutment portion on the first surface as an axis of symmetry. The first support portion is disposed on a side, away from the abutment portion, of the connection portion and connected to the connection portion. The carrier portion is disposed on a side, away from the connection portion, of the first support portion and connected to the support portion. The connection portion, the first support portion, and the carrier portion form a through-hole structure.

In some embodiments, the connection portion has an axisymmetric structure, an axis of symmetry of the connection portion is perpendicular to a length direction of the connection portion, and the deformation portion satisfies at least one of the following conditions: the abutment portion is symmetrically arranged about the axis of symmetry of the connection portion; the first support portion is symmetrically arranged about the axis of symmetry of the connection portion; and the through-hole structure is symmetrically arranged about the axis of symmetry of the connection portion.

In some embodiments, the through-hole structure includes a first through-hole edge close to the connection portion and a second through-hole edge close to the carrier portion, the first through-hole edge and the second through-hole edge forming a closed pattern; and a minimum distance between the first through-hole edge and a surface, close to the third sidewall, of the connection portion is less than or equal to a minimum distance between the second through-hole edge and a secured surface of the carrier portion secured to the second sidewall.

In some embodiments, the through-hole structure includes a first through-hole edge close to the connection portion and a second through-hole edge close to the carrier portion, the first through-hole edge and the second through-hole edge forming a closed figure; and

the closed pattern including a first angle close to the connection portion and a second angle close to the carrier portion side, the first angle being less than or equal to the second angle.

In some embodiments, an orthographic projection of the connection portion on the third sidewall encloses an orthographic projection of the carrier portion on the third sidewall.

In some embodiments, the abutment portion includes at least one convex structure, the convex structure includes a convex surface projecting toward the third sidewall, and the convex surface includes an abutment surface and a connection surface. The abutment surface is parallel to the second sidewall or the third sidewall, and the abutment surface is abutted against the third sidewall. The connection surface is disposed on a side, close to the first surface, of the abutment surface and connected to the abutment surface, the connection surface being beveled or curved.

In some embodiments, the limit structure further includes a second support portion, an orthographic projection of the second support portion on the first surface is disposed on either side of an orthographic projection of the deformation portion on the first surface. The second support portion is disposed between the second sidewall and the third sidewall and is connected to the second sidewall, and a distance between a surface, close to the third sidewall, of the second support portion and the third sidewall is less than a distance between the abutment surface and the third sidewall.

In some embodiments, the second sidewall includes a first sub-sidewall opposite to the first sidewall, a second sub-sidewall and a third sub-sidewall adjacent to the first sidewall, wherein the second sub-sidewall, the first sub-sidewall, the third sub-sidewall and the first sidewall are connected sequentially; wherein the limit structure is disposed at least on one of the first sub-sidewall, the second sub-sidewall and the third sub-sidewall.

In some embodiments, a quantity N of the limit structures connected to one of the first sub-sidewall, the second sub-sidewall and the third sub-sidewall satisfies a following relationship:

$$\frac{A}{N + 1} \leq L \leq \frac{A}{N} ;$$

wherein L is a minimum distance between the limit structure connected to the sub-sidewall and an end of the sub-sidewall, A is a length of the sub-sidewall, and the N limit structures are equally spaced along an extension direction of the sub-sidewall where the N limit structure are disposed.

In some embodiments, the backlight source further includes a frame clamped with the back plate, the frame is disposed on sides, close to the light guide plate, of the first sidewall and the second sidewall, and the limit structure and the frame are integrally formed;

a quantity N of the limit structures connected to one of the first sub-sidewall, the second sub-sidewall and the third sub-sidewall satisfies a following relationship:

N is greater than 3 in response to a first concentrated load maximum deflection being greater than or equal to a predetermined separating threshold;

N equals 3 in response to a second concentrated load maximum deflection being greater than or equal to the predetermined separating threshold and the first concentrated load maximum deflection being less than the predetermined separating threshold; or

N equals 2 in response to the second concentrated load maximum deflection being less than or equal to the predetermined separating threshold;

wherein the first concentrated load maximum deflection is a maximum deflection of the frame in the case that three limit structures are equally spaced on the sub-sidewall, and the second concentrated load maximum deflection is a maximum deflection of the frame in the case that two limit structures are equally spaced on the sub-sidewall; and

the N limit structures are equally spaced along an extension direction of the sub-sidewall where the N limit structure are disposed.

In some embodiments, a minimum distance between the limit structures and an end of the second sidewall connected to the limit structure ranges from 15 mm to 20 mm.

In some embodiments, a distance between two adjacent limit structures disposed on one second sidewall ranges from 50 mm to 70 mm.

In some embodiments, the limit structure is disposed between the third sidewall and the second sidewall opposite to the third sidewall.

In some embodiments, a groove configured to be engaged with the first support portion is disposed in the second sidewall, the first support portion is disposed in the groove, and an orthographic projection of the connection portion on the second sidewall encloses an orthographic projection of the groove on the second sidewall.

In some embodiments, the backlight source further includes a frame clamped with the back plate, the frame is disposed on sides, away from the light guide plate, of the first sidewall and the second sidewall; and the limit structure is in contact with the frame, or the limit structure and the frame are integrally formed.

In some embodiments, the backlight source further includes a frame clamped with the back plate, the frame is disposed on sides, close to the light guide plate, of the first sidewall and the second sidewall; and the limit structure and the frame are integrally formed.

In some embodiments, the limit structure and the back plate are integrally formed, the deformation portion and the abutment portion are formed by bending portions of the back plate, and the deformation portion includes a bending portion and a fixing portion; the bending portion is bent from the back plate towards the third sidewall, and the bending portion is disposed at a position corresponding to an orthographic projection of the third sidewall on the first surface; the fixing portion is connected to the bending portion and is parallel to the third sidewall; and the limit portion is connected to the fixing portion and is disposed on a side, close to the light guide plate, of the fixing portion.

In some embodiments, the backlight source further includes a light-shielding portion, the light-shielding portion is disposed on a surface, away from the light guide plate, of the bottom plate, and an orthographic projection of the light-shielding portion on the first surface of the bottom plate encloses an orthographic projection of the fixing portion on the first surface in the case that the fixing portion is not bent.

In some embodiments, an end portion, close to the light source, of the light guide plate is a protrusive corner engaged with an end portion of the light source.

According to some embodiments of the present disclosure, a display device is provided by embodiments of the present disclosure. The display device includes a display panel and the backlight source described in the above embodiments, wherein the display panel is disposed on a light-emitting side of the light guide plate.

### BRIEF DESCRIPTION OF DRAWINGS

Embodiments of the present disclosure are described in further detail below in conjunction with the accompanying drawings.

FIG. 1 is a schematic structural diagram of a limit structure of a backlight source in the related art;

FIG. 2 is a schematic structural schematic diagram of a backlight source in an assembled state according to some embodiments of the present disclosure;

FIG. 3 is a schematic structural diagram of a limit structure according to some embodiments of the present disclosure;

FIG. 4 is a schematic structural diagram of an abutment portion of a limit structure according to some embodiments of the present disclosure;

FIG. 5 is a schematic structural diagram of a limit structure according to some embodiments of the present disclosure;

FIGS. 6, 7, and 8 are schematic diagrams of through-hole structures of different structures according to some embodiments of the present disclosure;

FIG. 9 is a schematic diagram of a limit structure according to some embodiments of the present disclosure;

FIG. 10 is a schematic diagram of the limit structure in an assembled state shown in FIG. 3;

FIG. 11 is a schematic structural diagram of the limit structure shown in FIG. 3 applied in the frame clamped with the outside of the back plate;

FIG. 12 is a schematic diagram of a limit structure, a light guide plate, and a back plate in an assembled state under a room temperature according to some embodiments of the present disclosure;

FIG. 13 is a schematic diagram of a limit structure, a light guide plate and a back plate in an assembled state under a high temperature according to some embodiments of the present disclosure;

FIG. 14 is a schematic structural diagram of the frame integrally formed with the limit structure shown in FIG. 3 according to another embodiments of the present disclosure;

FIG. 15 is a schematic structural diagram of the frame integrally formed with the limit structure shown in FIG. 9, in the case that the frame is clamped with the inside of the back plate according to another embodiments of the present disclosure;

FIG. 16 is a schematic structural diagram of the back plate integrally formed with the limit structure according to another embodiments of the present disclosure; and

FIG. 17 is a schematic structural diagram of the frame subjected to force analysis according to some embodiments of the present disclosure.

### DETAILED DESCRIPTION

In order to make the objects, technical solutions and advantages of the present disclosure clearer, embodiments of the present disclosure are described in further detail below in conjunction with the accompanying drawings.

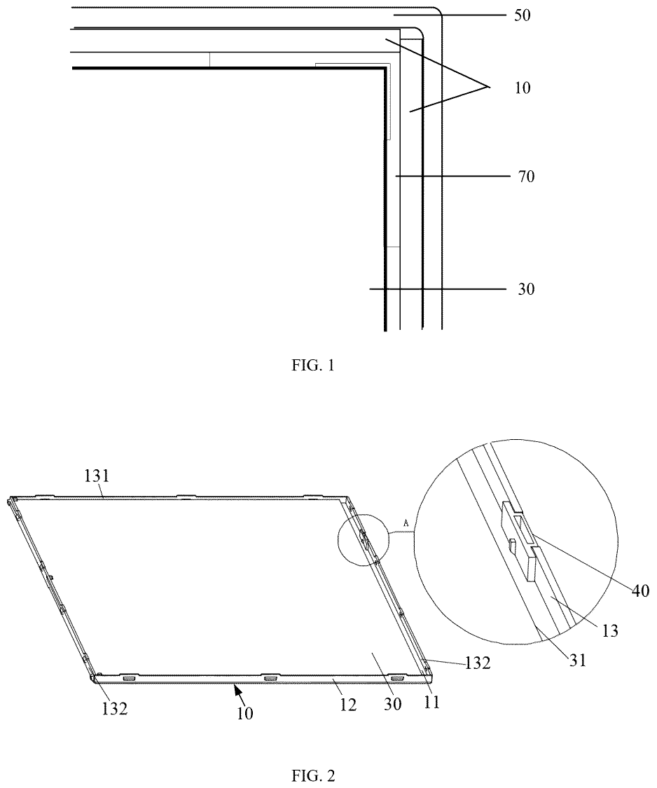

In the related art, the limit structure of the backlight source is generally a set of L-type limit members 70 (may be rubber structural members) disposed at the upper left corner and right corner of the back plate 10. The light guide plate 30 and the limit members 70 are fixed in the back plate 10 with an interference fit. For the problem of abnormal noise and poor reliability of the backlight source with the limit structure in FIG. 1, the inventor, upon a large quantity of reliability tests and researches, conclude that the main reason for the backlight source to have the above problems is that the limit members cannot effectively fix the light guide plate.

At present, the material of light guide plate is PC (polycarbonate) or PMMA (polymethyl methacrylate). Under a high temperature, the light guide plate 30 expands and squeezes the limit member 70 at the corner, causing the limit member 70 to be deformed. In the case that the light guide plate 30 contracts upon returning to a room temperature, however, due to the difference between the expansion and contraction amounts of the light guide plate 30, the fit between the limit member 70 and the light guide plate 30 changes from an interference fit to a transition fit or a clearance fit, which makes it impossible for the limit member 70 to be fixed with the light guide plate 30. The gap between the limit member 70 and the light guide plate 30 causes the light guide plate 30 to shake in the back plate 10, and the light guide plate 30 is subjected to extrusion and collision with the back plate 10 and other the light source components under vibration and other conditions, resulting in abnormal noise and other defects.

In view of this, embodiments of the present disclosure provide a backlight source and a display device.

The embodiments of the present disclosure provide a backlight source, as shown in FIG. 2. The backlight source includes: a back plate 10, a light source 20, a light guide plate 30, and a plurality of limit structures 40. The back plate 10 includes a bottom plate 11, a first sidewall 12 perpendicular to a first surface of the bottom plate 11 and connected to the bottom plate 11, and a plurality of second sidewalls 13 perpendicular to the first surface of the bottom plate 11 and connected to the bottom plate. The light guide plate 30 is disposed on the first surface. The light guide 30 includes a plurality of third sidewalls 31 opposite to and parallel to the plurality of second sidewalls 13. The light source 20 is disposed on the first surface and at least disposed on the first sidewall 12 (i.e., at least a portion of the light source 20 is disposed between the first sidewall 12 and the light guide 30). A plurality of limit structures 40 are configured to secure the light guide plate 30. Each of the limit structures 40 is disposed on a side, close to the second sidewall 13 opposite to the third sidewall 31, of the third sidewall 31 and is abutted against the third sidewall 31. Each of the limit structures 40 is connected to the second sidewall 13 opposite to the third sidewall 31 with which the limit structure 40 is contacted.

In some embodiments of the present disclosure, a plurality of limit structures 40 are disposed on at least one second sidewall 13 of the back panel 10 and are abutted against the third sidewall 31 opposite to the at least one second sidewall 13. Instead of being disposed at the top end of the light guide plate 30, the limit structures 40 are disposed on the side, facing the second sidewall 13 of the back plate 13, of the corresponding third sidewall 31, and the plurality of limit structures 40 are disposed along the extension direction of the third sidewall 31 to limit the light guide plate 30. Each of the limit structures 40 needs to fit with only one sidewall of the light guide plate 30, which is simple to be assembled and can effectively limit and fix the light guide plate 30, and has a wide range of application prospects.

In the embodiments of the present disclosure, the limit structure 40 being connected to the second sidewall 13 includes directly connection or indirectly connection through other components. In some embodiments, the connection manners include, but are not limited to, clamping connection, injection molding connection, integral forming, and the like. All of these connection manners can simplify the assembly process of the backlight source.

As shown in FIG. 2, the second sidewall 13 includes a first sub-sidewall 131 opposite to the first sidewall 12, a second sub-sidewall 132, and a third sub-sidewall 133 adjacent to the first sidewall 12. According to the dimensional design, a space is formed between the light guide plate 30 and these sidewalls of the back plate 10. A first space is formed between the first sub-sidewall 131 and the third sub-sidewall 31 opposite to the first sub-sidewall 131, a second space is formed between the second sub-sidewall 132 and the third sidewall 31 opposite to the second sub-sidewall 132, and a third space is formed between the third sub-sidewall 133 and the third sidewall 31 opposite to the third sub-sidewall 133.

In some embodiments, at least a portion of the limit structure 40 is disposed between the first sub-sidewall 131 and the third sidewall 31 opposite to the first sub-sidewall 131, between the second sub-sidewall 132 and the third sidewall 31 opposite to the second sub-sidewall 132, or between the third sub-sidewall 133 and the third sidewall 31 opposite to the third sub-sidewall 133. The limit structure 40 in the embodiments is not disposed at the top edge of the light guide plate 30, but is disposed in the space between the sidewalls of the light guide plate 30 and the sidewalls of the back plate 10. During expansion or contraction of the light guide plate 30, by providing a plurality of limit structures 40 in the space, the sidewall surface of the light guide plate 30 can be uniformly fixed, i.e., the force formed by each of the limit structures 40 and the light guide plate 30 upon being abutted against the sidewalls of the light guide plate 30 is uniform, and the arrangement prevents the light guide plate 30 from being deflected.

As shown in FIG. 2, exemplarily, the limit structures 40 are disposed on three third sidewalls 31 of the light guide plate 30. In another example, it is also possible to dispose the plurality of limit structures 40 only on the first sub-sidewall 131 and the third sidewall 31 opposite to the first sub-sidewall 131. In still another example, the plurality of limit structures 40 are dispose only on the second sub-sidewall 132 and the third sidewall 31 opposite to the second sub-sidewall 132. In still another example, the plurality of limit structures 40 are dispose in two of the first space, the second space, and the third space. In other words, the limit structure 40 in the embodiments of the present disclosure has a plurality of arrangements, which can be designed by those skilled in the art according to the actual application, and is not be repeated herein.

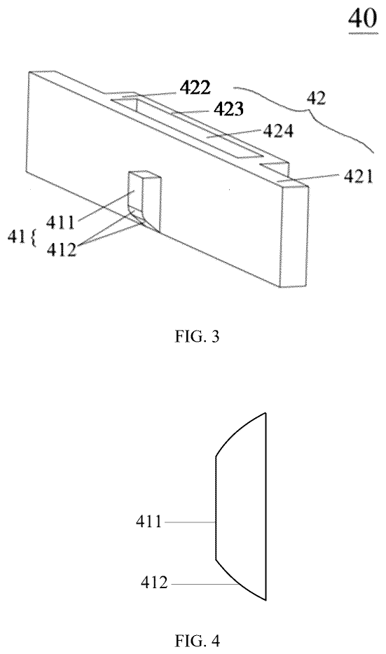

In some embodiments, as shown in FIG. 3, the limit structure 40 includes an abutment portion 41 attached to the third sidewall 31; and a deformation portion 42 connected to the abutment portion 41. The deformation portion 42 is configured to be deformed to cause the abutment portion 41 to be abutted against the third sidewall 31. The deformation portion 42 is connected to the second sidewall 12 of the back panel 10.

In the embodiments, in the case that the light guide plate 30 and the limit structure 40 are assembled and fixed, the deformation direction of the deformation portion 42 is the same as the expansion direction or contraction direction of the light guide plate 30. Exemplarily, under the room temperature, the light guide plate 30 does not expand or contract, and the limit structure 40 in the embodiments of the present disclosure and the third sidewall 31 of the light guide plate 30 form an interference fit. That is, the deformation portion 42 deforms under the room temperature and is in a first deformation state, and the contact portion 41 contacts the third sidewall 31 of the light guide plate 30 under the room temperature. In the case that the light guide plate 30 expands under the high temperature, the deformation portion 42 performs a second deformation in the expansion direction of the light guide plate 30 under the action of the expansion tension of the light guide plate 30, and is in a second deformation state. That is, in the case that the light guide plate 30 expands, the limit structure 40 in the embodiments of the present disclosure can also effectively fix the light guide plate 30.

In the case that the light guide plate 30 contracts from the expansion state, the amount of expansion of the light guide plate 30 in the direction from the second sidewall 13 to the corresponding third sidewall 31 decreases, i.e., the expansion force acting on the limit structure 40 decreases. In this way, the limit structure 40 in the embodiments of the present disclosure performs a third deformation along the direction from the second sidewall 13 to the third sidewall 31, and the amount of the third deformation is smaller than the amount of the second deformation. The limit structure 40 in the embodiments of the present disclosure is capable of deforming in the same direction as the light guide plate 30 with the deformation of the light guide plate 30. Therefore, the limit structure 40 in the embodiments of the present disclosure is capable of forming an effective limit fixing of the light guide plate 30 when conducting tests such as high temperature, low temperature, or vibration, thereby avoiding the phenomenon shown in FIG. 1 in which the light guide plate 30 moves due to a change of the distance between the light guide plate 30 and the limit member 70 when the light guide plate 30 performs deformation.

In some embodiments of the present disclosure, the limit structure 40 shown in FIG. 3 is illustrated as an example.

In some embodiments, as shown in FIG. 3, the abutment portion 41 includes a convex structure including a convex surface projecting toward the third sidewall 31. In the embodiments, the convex abutment portion 41 is utilized to be abutted against the third sidewall 31 of the light guide plate 30, and the deformation portion 42 is utilized to cushion the abutment force generated during the interference fit with the light guide plate 30 and the deformation force generated during the deformation of the light guide plate 30, thereby realizing limit fixing of the light guide plate 30 in various states.

As shown in FIGS. 3 and 4, the convex surface includes an abutment surface 411 parallel to the second sidewall 13 or the third sidewall 31, and the abutment surface 411 forms an abutment region with the third sidewall 31. The abutment surface 411 in the embodiment is a flat surface, such that the contact area between the abutment portion 41 and the third sidewall 31 is ensured, and in the case that the deformation portion 42 deforms under the action of the force between the light guide plate 30 and the limit structure 40, the abutment portion 41 deforms only in a direction parallel to the first surface. Based on the fixed light guide plate 30, it is also possible to prevent the deflection of the light guide plate 30.

As shown in FIG. 3, the convex surface further includes a connection surface 412 connected to the abutment surface 411. The connection surface 412 is disposed on a side, close to the first surface, of the abutment surface 411. The connection surface 412 is beveled or curved. In the embodiment, the connection surface 412 has a slope. Exemplarily, the structure of the connection surface 412 is a beveled surface as shown in FIG. 3 or a curved surface as shown in FIG. 4. During the assembly of the limit structure 40 and the light guide plate 30, the connection surface 412 can uniformly push the light guide plate 30 to move in the assembly space, such that the light guide plate 30 is subjected to a uniform force, the precision of the assembly of the light guide plate 30 is ensured, and the design of the connection surface 412 can also protect the surface of the light guide plate 30 from being scratched to ensure the display effect.

In some embodiments, as shown in FIG. 3, the deformation portion 42 includes a connection portion 421, a first support portion 422, and a carrier portion 423. The connection portion 421 is connected to the abutment portion 31 for carrying the abutment portion 41. An orthographic projection of the connection portion 421 on the first surface is axisymmetric about an orthographic projection of the abutment portion 41 on the first surface as an axis of symmetry. In other words, the connection portion 421 is an axisymmetric structure and has an axis of symmetry perpendicular to the length direction of the connection portion 421. The abutment portion 41 is disposed in the middle of the connection portion 421 in the length direction of the connection portion 421 and is symmetrically arranged about the axis of symmetry of the connection portion 421. The first support portion 422 is disposed on a side, away from the abutment portion 41, of the connection portion 421 and is connected to the connection portion 421 for cushioning an elastic force in the case that the abutment portion 41 is deformed. The carrier portion 423 is disposed on the side, away from the connection portion 421, of the first support portion 422 and is connected to the first support portion 122 for carrying the limit structure 40.

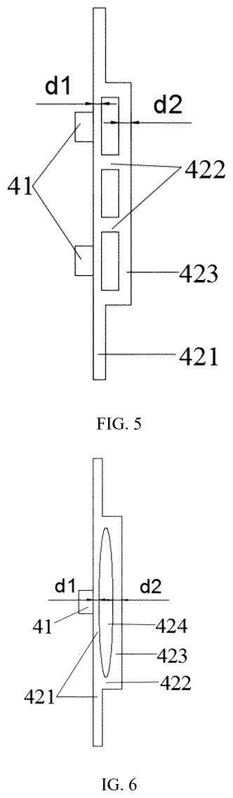

The first support portion 422 has an axisymmetric structure, and an orthographic projection of the first support portion 422 on the first surface is axisymmetric about the orthographic projection of the abutment portion 41 on the first surface as the axis of symmetry. That is, the first support portion 422 is symmetrically disposed on both sides of the abutment portion 41 in the length direction of the connection portion 421. Exemplarily, as shown in FIG. 3, the first support portion 422 includes a plurality of support columns connected between the connection portion 421 and the carrier portion 423. Exemplarily, the support columns are two as shown in FIG. 3, or, in another example, as shown in FIG. 5, the support columns are four. In the embodiments of the present disclosure, the quantity of support columns is not limited, and with the design criterion that the deformation portion 42 is capable of deforming according to the abutment force of the abutment portion 41 abutted against the third sidewall 31. Those skilled in the art is able to set the quantity of support columns based on the actual application, which is not repeated in details herein.

In some embodiments, the orthographic projection of the connection portion 421 on the third sidewall 31 encloses the orthographic projection of the carrier portion 423 on the third sidewall 31. That is, the orthographic projection of the carrier portion 423 on the third sidewall 31 is inside the orthographic projection of the connection portion 421 on the third sidewall 31.

As shown in FIGS. 2 and 3, the abutment portion 41 is disposed at a middle position of the connection portion 421, such that when the abutment force generated by the abutment portion 41 and the third sidewall 31 of the light guide plate 30 is transmitted to the deformation portion 42, the abutment portion 41 can provide the greatest deformation force to the connection portion 421, and the deformation portion 42 can achieve a larger deformation with a smaller structure to match the deformation of the light guide plate 30, thereby fixing the light guide plate 30.

In another embodiment, as shown in FIG. 5, the abutment portion 41 includes two convex structures, the two convex structures are symmetrically disposed about an axis of symmetry of the connection portion 421, and each of the convex structures is disposed between adjacent support columns. It is to be noted that the quantity of convex structures included in the abutment portion 41 is determined based on actual requirements. For example, the quantity of convex structures is three, etc., which is not limited in the embodiments of the present disclosure. In the embodiments of the present disclosure, the limiting performance of the abutment portion 41 on the limit structure 40 is further improved by disposing a plurality of convex structures on the connection portion 421 of the limit structure 40.

As shown in FIGS. 3 to 9, in some embodiments, the deformation portion 42 in the embodiment of the present disclosure is provided with a through-hole structure 424 to have good deformation performance. The connection portion 421, the first support portion 422, and the carrier portion 423 form the through-hole structure 424, and the through-hole of the through-hole structure 42 extends from the surface, parallel to the light-emitting surface of the light guide plate 30, of the deformation portion 42 to the first surface, i.e., extends in the direction of inwardly toward the surface in the top-viewed state as shown in FIG. 2.

The first support portion 422 is disposed on the outside of the through-hole structure 424 to form a support. The carrier portion 423 is disposed on the side, away from the third sidewall 31, of the through-hole structure 424 for securing the limit structure 40. The connection portion 421 is disposed on the side, close to the third sidewall 31, of the through-hole structure 424. The position of the connection portion 421 corresponding to the through-hole structure 424 deforms under the force of the light guide plate 30 fitting with the abutment portion 41.

In some embodiments of the present disclosure, the through-hole structure 424 is symmetrically arranged about the axis of symmetric of the connection portion 421, such that the position of the convex structure corresponds to the through-hole structure 424, and the position of the connection portion 421 corresponding to the through-hole structure 424 deforms under the action of the force of the light guide plate 30 fitting with the abutment portion 41.

In some embodiments, as shown in FIGS. 5 to 8, in the direction from the first sidewall 12 to the first sub-sidewall 131, i.e., in the direction parallel to the surface from bottom to top in the figure, the orthographic projection of the through-hole structure 424 on the first surface is at the mid-position of the deformation portion 42, such that deformation of the connection portion 421 is uniform, and the equilibrium formed by the abutment portion 41 and the light guide plate 30 can be maintained, realizing a more effective limitation.

In some embodiments, the through-hole structure 424 includes a first through-hole edge 4241 close to the connection portion 421 and a second through-hole edge 4242 close to the carrier portion 423. The first through-hole edge 4241 and the second through-hole edge 4242 form a closed pattern. Exemplarily, as shown in FIGS. 5 to 8, the orthographic projection of the through-hole structure 424 on the first surface is one of a rectangle, a diamond, a triangle, an oval, and a trapezoid. The shapes of the orthographic projections of the through-hole structures 424 of the limit structures 40 on the first surface can be the same or different.

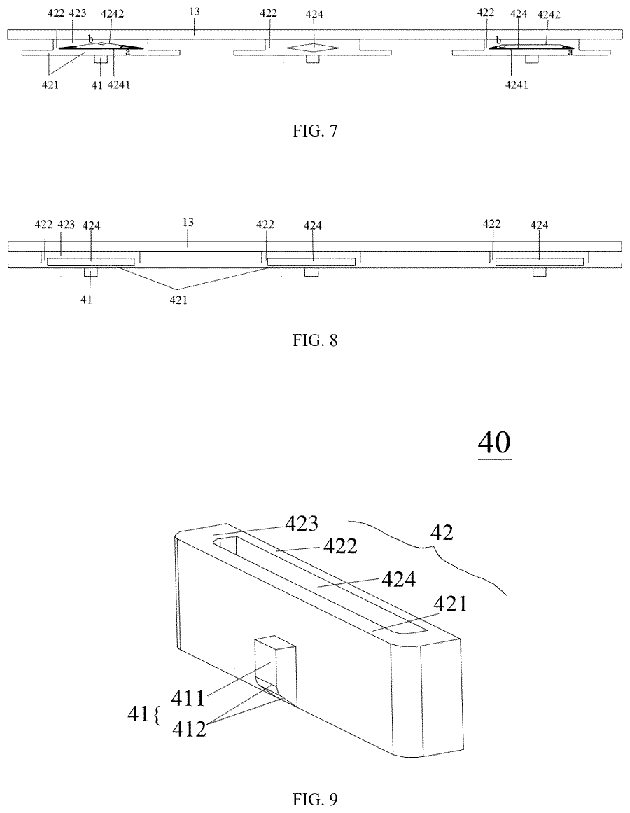

In some embodiments, as shown in FIGS. 5 to 8, the first through-hole edge 4241 includes one or more of an arcuate edge, a straight line edge, and a curved edge, and the second through-hole edge 4242 includes one or more of an arcuate edge, a straight line edge, and a curved edge. Exemplarily, in the case that the first through-hole edge 4241 is a straight line edge and the second through-hole edge 4242 is a curved edge with one bend, the closed pattern formed by the first through-hole edge 4241 and the second through-hole edge 4242 is a triangle, such as the leftmost limit structure in FIG. 7. In another example, in the case that the first through-hole edge 4241 is a curved edge with two bends, and the second through-hole edge 4242 is a curved edge with two bends, the closed pattern formed by the first through-hole edge 4241 and the second through-hole edge 4242 is a polygon, such as the middle limit structure in FIG. 7. In another example, in the case that the first through-hole edge 4241 and the second through-hole edge 4242 are the same curved edge, the closed pattern formed is oval or circular, as shown in FIG. 6.

In other words, the specific shape of the through-hole structure 424 is not limited in the embodiments of the present disclosure, and with the design criterion that the orthographic projection of the through-hole structure 424 on the first surface is a closed pattern. The deformation portion 42 is capable of deforming based on the abutment force of the abutment portion 41 being abutting against third sidewall 31, those skilled in the art is able to arrange the through-hole structure 424 based on the practical application, which is not repeated herein.

To ensure compatibility of the deformation performance and service life of the limit structure 40, in some embodiments, as shown in FIGS. 5 and 6, the minimum distance d1 between the first through-hole edge 4241 and the surface, close to the third sidewall 31, of the connection portion 421 is less than or equal to the minimum distance d2 between the second through-hole edge 4242 and the surface, away from the connection portion 421, of the carrier portion 423.

In the embodiments, the design of the position of the through-hole structure 424 is, for example, the rectangular through-hole structure 424 shown in FIG. 7. In the case that the through-hole structure 424 is disposed in the deformation portion 42, the connection portion 421 deforms at the position corresponding to the through-hole structure 424, and the carrier portion 423 forms a fixation at the position corresponding to the through-hole structure 424. The smaller the thickness (dimension in the direction from the third sidewall 31 to the second sidewall 13) of the connection portion 421 is, the greater its deformation performance is, and the greater the thickness (dimension in the direction from the third sidewall 31 to the second sidewall 13) of the carrier portion 423 is, thus having better support performance. Therefore, in the embodiments of present disclosure, the thickness of the connection portion 421 and the thickness of the carrier portion 423 are arranged. That is, the thickness of the connection portion 421 is a minimum distance d1 between the edge, close to the connection portion 421, of the through-hole of the through-hole structure 424 and the surface, close to the third sidewall 31, of the connection portion 421, and the thickness of the carrier portion 423 is a minimum distance d2 between the through-hole edge, close to the carrier portion 423, of the through-hole structure 424 and the fixing surface of the carrier portion 423 fixed to the second sidewall 13. In the embodiments of present disclosure, the thickness d1 of the connection portion 421 is be less than the thickness d2 of the carrier portion 423, which ensures both the deformation performance of the connection portion 421 and the support performance of the carrier portion 423.

Exemplarily, as shown in FIG. 6, the through-hole structure 424 is an ellipse, and the first through-hole edge 4241 and the second through-hole edge 4242 are curved edges. A minimum distance d1 between the first through-hole edge 4241 and the connection portion 421 is the thickness of the connection portion 421, and a minimum distance d2 between the second through-hole edge 4242 and the carrier portion 423 is the thickness of the carrier portion 423, such that the thickness of the connection portion 421 is less than or equal to the thickness of the carrier portion 423. For the through-hole structure 424 having other shapes, the thickness of the connection portion 421 and the thickness of the carrier portion 423 are referred to the above embodiments, which is not repeated herein.

In some embodiments, due to the large quantity of shapes of the through-hole structure, as shown in FIG. 7, the minimum distance d1 between the first through-hole edge 4241 and the surface, close to the third sidewall 31, of the connection portion 421 is equal to the minimum distance d2 between the second through-hole edge 4242 and the fixing surface of the carrier portion 423 fixed to the second sidewall 13, which is further designed in the embodiments.

In some embodiments, the closed pattern formed by the orthographic projection of the first through-hole edge 4241 and the second through-hole edge 4242 on the first surface includes a first angle a close to the connection portion 421 and a second angle b close to the carrier portion 423, the first angle a being less than or equal to the second angle b.

In the embodiments, taking the triangular through-hole structure shown in FIG. 7 as an example, the second angle b of the second through-hole edge 4242 is an obtuse angle formed by the two short edges, the first angle a of the first through-hole edge 4241 is an acute angle formed by the longest edge and one of the short edges, and the second angle b is smaller than the first angle a. That is, in the embodiments of the present disclosure, the longest edge of the triangle is close to the connection portion 421, and the two oblique edges of the triangle is close to the carrier portion 423, such that the first through-hole edge 4241 has a thinner thickness close to the connection portion 421 and the second through-hole edge 4242 has a larger thickness close to the carrier portion 423, which further ensures the deformation performance of the connection portion 421, and ensures the support performance of the carrier portion 423.

In another example, taking the trapezoidal through-hole structure shown in FIG. 7 as an example, the second angle b near the carrier portion 423 is an obtuse angle formed by the beveled edge and the top edge of the trapezoidal shape, the first angle a close to the connection portion 421 is an acute angle formed by the beveled edge and the bottom edge of the trapezoidal shape, and the second angle b is smaller than the first angle a. That is, in the embodiments of the present disclosure, the bottom edge of the trapezoidal shape is close to the connection portion 423, and the top edge of the trapezoidal shape is close to the carrier portion 423. The distance between the first support portion 422 and the trapezoidal beveled edge, i.e., the length of the first support portion 422 in the extension direction of the second sidewall 13, i.e., the width of the first support portion 423, is progressively increased in the direction from the connection portion 421 to the carrier portion 423. In other words, the cross-sectional area of the first support portion 422 is increasing in the direction from the connection portion 421 to the carrier portion 423, such that the thickness corresponding to the side of the first through-hole edge 4241 close to the connection portion 421 is thinner, and the thickness corresponding to the side of the second through-hole edge 4242 close to the carrier portion 423 is larger, which further ensures the deformation performance of the connection portion 421, and ensures the supporting performance of the carrier portion 423.

In some embodiments, the first through-hole edge or the second through-hole edge is a special shaped edge. In some embodiments, the first through-hole edge includes a tangent angle formed by a tangent line of an arcuate edge, a straight line edge angle formed by an adjacent straight line edge, or a bend angle at a bend in a curved edge. The angle of pinch corresponding to the edge closest to the connection portion is the first angle of pinch of the first through-hole edge.

The second through-hole edge includes a tangent angle formed by a tangent line of the arcuate edge, a straight line edge angle formed by an adjacent straight line edge, or a bend angle at a bend of the curved edge. The angle of pinch corresponding to the edge nearest to the carrier portion is the second angle of pinch of the second through-hole edge.

In the embodiments, the design for the through-hole structure is polygonal, multi-arc, or shaped. In the structure, a plurality of angles are present in the first through-hole edge, and a plurality of angles are present in the second through-hole edge. In the embodiments, the first angle is the angle of the first through-hole edge closest to the edge of the connection portion, because the deformation performance is best at this position. The second angle is the angle of the second through-hole edge closest to the edge of the carrier portion, and the first angle in the embodiments is smaller than or equal to the second angle, which enables the connection portion to have a good performance of the sex deformation and enables the carrier portion to have a good performance of the carrying. The first angle of the embodiments is smaller than or equal to the second angle, which enables the connection portion to have good deformation properties and the carrier portion to have good carrying properties.

The above design is some embodiments of the through-hole structure 424 in the limit structure 40, and with the above arrangements, the limit structure 40 in the embodiments of the present disclosure has the advantages of good limiting performance, long service life, and being able to prevent the deflection of the light guide plate 30.

In some examples, as shown in FIGS. 2 to 7, in the embodiments of the present disclosure, the orthographic projection of the connection portion 421 on the third sidewall 31 encloses the orthographic projection of the carrier portion 423 on the third sidewall 31. That is, the orthographic projection of the carrier portion 423 on the third sidewall 31 is within the orthographic projection of the connection portion 421 on the third sidewall 31. This arrangement enables the connection portion 421 to be overlapped with the back plate 10, in the case that the carrier portion 423 and the first support portion 422 are disposed in the groove of the second sidewall 13 of the back plate 10 (see FIG. 2), and the connection portion 421 at overlapping position is utilized to further limit the limit structure 40. In one example, the length of one side of the overlapping region formed by the connection portion 421 and the back plate 10 ranges from 3 to 5 mm, which is a dimension in the extension direction of the orthographic projection of the connection portion 421 on the first surface shown in FIG. 2.

In another example, as shown in FIG. 8, the connection portions 421 of the plurality of limit structures 40 disposed on the same sub-sidewall are connected sequentially. That is, the connection portions 421 of the plurality of limit structures 40 are integrally formed. This arrangement can further simplify the overall structure of the plurality of limit structures 40 disposed on the same sub-sidewall and improve the assembly efficiency. In one example, the length of the connection portion 421 along the extension direction is the same as the length of the back plate 10 or the frame with the backlight source in that direction.

In another example, as shown in FIG. 9, the orthographic projection of the connection portion 421 on the second sidewall 13 of the embodiments coincides with the orthographic projection of the carrier portion 423 on the second sidewall 13. That is, the length of the connection portion 421 is the same as the length of the carrier portion 423, and the length is a dimension in the extension direction of the connection portion 421.

With the above arrangements regarding the connection portion 421 and the carrier portion 423, the limit structure 40 in the embodiments of the present disclosure has a variety of structural designs, and those skilled in the art carry out the structural of the carrier portion 423 and the connection portion 421 based on the actual application, which is not repeated herein.

The limit structure 40 in the embodiments are disposed between different third sidewalls 31 and second sidewalls 13. Based on the effective fixing of the light guide plate 30, it is also necessary to ensure the positional accuracy of the light guide plate 30, and the mounting position of the limit structure 40 is designed in the embodiments.

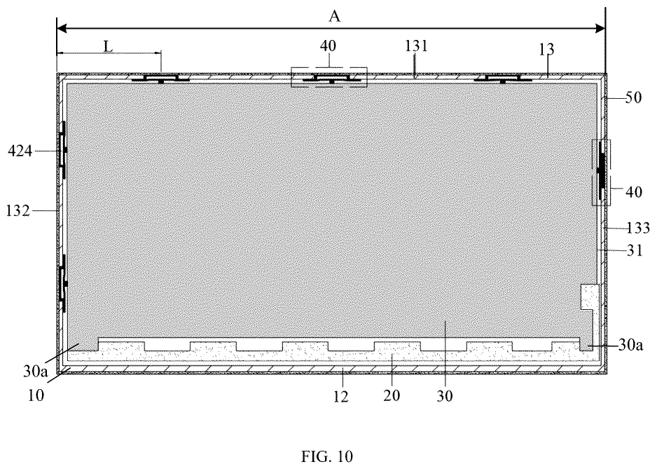

FIG. 10 is a schematic diagram of combination relationship of the limit structure 40 with each member of the application shown in FIG. 3 in the backlight source. In some embodiments, as shown in FIG. 10, a through-hole structure 424 is disposed on the deformation portion 42 of the limit structure 40 disposed on the first sub-sidewall 131. The through-hole structure 424 is disposed on the deformation portion 42 of the limit structure 40 disposed on the second sub-sidewall 132 or the third sub-sidewall 133.

In the embodiments, the first sub-sidewall 131 is opposite to the first sidewall 12 where the light source 20 is disposed, and the first sidewall 12 is fixedly disposed, such that the through-hole structures 424 are disposed on the limit structures 40 on the first sub-sidewall 131, and the limit structure 40 disposed on the first sub-sidewall 131 is utilized to limit the light guide plate 30 in the upward and downward directions shown in FIG. 2.

The second sub-sidewall 132 and the third sub-sidewall 133 are opposite to each other. In order to prevent a situation in which the light guide plate 30 becomes skewed due to a deformation force being simultaneously applied to the opposite sidewalls of the light guide plate 30 when the deformation portion 42 deforms, in the case that the limit structure 40 is disposed on both the second sub-sidewall 132 and the third sub-sidewall 133, only one of the sub-sidewalls of the limit structure 40 is provided with the through-hole structure 424. That is, in the case that the through-hole structure 424 is disposed on the limit structure 40 disposed on the second sub-sidewall 132, the through-hole structure 424 is not disposed on the third sub-sidewall 133 of the limit structure 40, or in the case that the through-hole structure 424 is disposed on the third sub-sidewall 133 of the limit structure 40, the through-hole structure 424 is not disposed on the second sub-sidewall 132 of the limit structure 40, such that the second sub-sidewall 132 and the limit structure 40 of the third sub-sidewall 133 are arranged to limit the light guide plate 30 in the left and right directions shown in FIG. 10.

In another example, the arrangement of the through-hole of the above limit structure 40 is based on the arranging the limit structure 40 on all three sub-sidewalls. In the embodiments of the present disclosure, the limit structure 40 is disposed on one of the third sub-sidewall 133 and the second sub-sidewall 132, and the limit structure 40 is not disposed on the other sub-sidewall, which is also capable of forming a limit for the light guide plate 30 in the left-right direction shown in FIG. 10. The arrangement is also capable of limit the light guide plate 30 in the left and right directions shown in FIG. 10, which can be designed by those skilled in the art based on the actual application, which is not repeated herein.

In some embodiments, as shown in FIG. 10, the backlight source further includes a frame 50 clamped with the back plate 10. The frame 50 is disposed on sides, away from the light guide plate 30, of the first sidewall 12 and the second sidewall 13. The backlight source in the embodiments is an external clamped structure, i.e., upon the frame 50 and the back plate 10 being assembled, the frame 50 is disposed on the outer side of the second sidewall 13 of the back plate 10.

In the embodiments, a groove 14 configured to be engaged with the first support portion 422 is disposed in the back plate 10, and a space for placing the carrier portion 423 is formed on sides, toward the third sidewall 31, of the groove 14 and the sidewall of the frame 50. The orthographic projection of the connection portion 421 on the second sidewall 13 encloses the orthographic projection of the groove 14 on the second sidewall 13. That is, the connection portion 421 is overlapped with the back plate 10 at each end of the groove 14, and the connection portion 421 in the overlapping region is able to form a limit with the back plate 10, thereby fixing the limit structure 40.

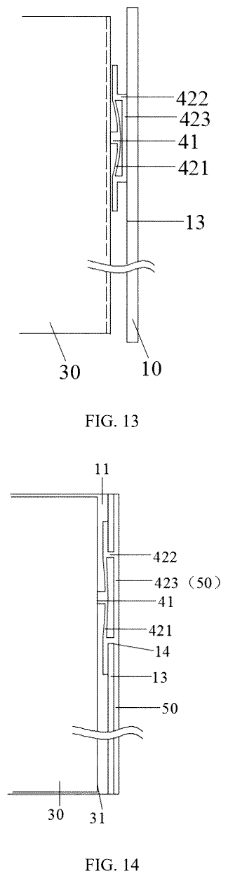

In some examples, as shown in FIGS. 12 and 13, the limit structure 40 is disposed between the second sidewall 13 and the third sidewall 31 opposite to the second sidewall 13 of the backboard 10.

The plurality of limit structures 40 are fixedly disposed between at least one second sidewall 13 and a third sidewall 31 opposite to the second sidewall 13, such that the light guide plate 30 is fixed. In the embodiments of the present disclosure, the plurality of limit structures 40 are fixedly disposed between at least one second sidewall 13 of the back plate 10 and a third sidewall 31 opposite to the second sidewall 13, and in the embodiments, the limit structures 40 are not disposed on the embodiments limit structure 40 is not disposed at the top edge of the light guide plate 30, but is disposed between the third sidewall 31 of the light guide plate 30 and the second sidewall 13 of the back plate 10. The plurality of limit structures 40 are disposed between these two sidewalls along the extension direction of the sidewalls to limit the light guide plate 30, and the limit structure 40 is simple to be assembled, which effectively limits and fixes the light guide plate 30, and has a wide range of application prospects.

FIG. 12 is a schematic diagram of the assembly state of the back plate, the limit structure 40, and the light guide plate 30 in the embodiment of the present disclosure under the room temperature. As shown in FIG. 12, the light guide plate 30 does not expand under the room temperature, the limit structure 40 is assembled between the light guide plate 30 and the back plate 10, and the limit structure 40 and the light guide plate 30 are interference fit. Exemplarily, the interference amount ranges from 0.3 to 0.5 mm. In the case that the abutment portion 41 is abutted against the light guide plate 30, the abutment portion 41 transmits the abutment force generated by the interference fit to the connection portion 421, and the connection portion 421 deforms towards the second sidewall 13. With the support of the first support portion 422 and the fixation of the carrier portion 423, the amount of deformation of the deformation portion 42 is limited. A state of equilibrium is formed between the limit structure 40 and the light guide plate 30, such that the light guide plate 30 can be effectively fixed and the light guide plate 30 is prevented from being displaced within the back plate 10.

FIG. 13 is a schematic diagram of an assembly state of the back plate 10, the limit structure 40, and the light guide plate 30 in some embodiments of the present disclosure under a high temperature. As shown in FIG. 13, under the high temperature, the light guide plate 30 expands itself and expands and deforms from the original position of the dashed line to the position of the solid line. The third sidewall 31 of the light guide plate 30 moves in the direction of the second sidewall 13. In the state of contact between the contact portion 41 and the light guide plate 30, the contact force between the light guide plate 30 and the contact portion 41 becomes larger upon the deformation of the light guide plate 30. The contact force is transmitted to the connection portion 421, and the connection portion 421 deforms more in the direction of the second sidewall 13 under the action of this contact force. With the support of the first support portion 422 and the fixation of the carrier portion 423, a state of equilibrium can again be formed between the limit structure 40 and the expanded light guide plate 30, such that it can always be ensured that the light guide plate 30 is subjected to sufficiently binding force within the back plate 10 to effectively fix the light guide plate 30.

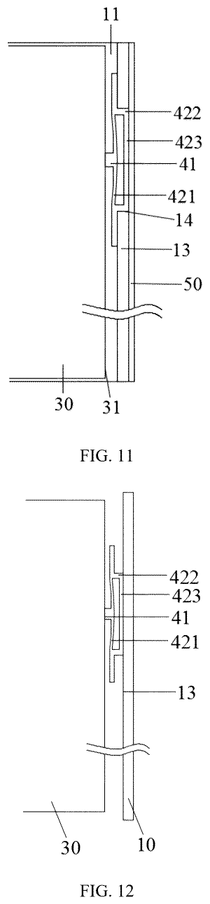

In some embodiments, as shown in FIGS. 10 and 11, the limit structure 40, the frame 50, and the back plate 10 are all separate members.

In the case that the limit member 70 as shown in FIG. 1 is in an L-shape, and the assembly position is at the apex edge of the light guide plate 30, it is necessary to ensure that the surface of the limit member 70 is in complete attached with the surface of the back plate 10 during assembly. The assembly of the limit member has a certain degree of difficulty, which is directly related to the product quality of the backlight source. In the case that the assembly of manual operation is adopted, due to the small size of the limit member, assembly problems such as assembly offset are likely to occur, and the assembly efficiency is relatively low, and in the case that the assembly method of machine assembly is adopted, the assembly cost is not substantially increased.

Based on the above problems, embodiments of the present disclosure carry out a structural combination design of the limit structure 40, the back plate 10, and the frame 50.

In some embodiments, the limit structure 40 and the back plate 10 are integrally formed. Exemplarily, in the case that the design of the back plate 10 is completed, the limit structure 40 is disposed on the back plate 10 by a process such as injection molding, such that the limit structure 40 and the back plate 10 are integrally formed with glue and iron.

In another optional embodiment, as shown in FIG. 14, the frame 50 and the limit structure 40 are integrally formed, and the carrier portion 423 and the second support portion 43 are both sidewalls of the frame 50 toward the side of the third sidewall 31. In the embodiments of the present disclosure, the frame 50 and the limit structure 40 are integrally formed, in this way, the limit structure 40 is a portion of the frame 50. This arrangement can avoid the assembly of the limit structure 40, thereby improving the assembly efficiency. In the embodiments of the present disclosure, the frame is clamped with the back plate, which can further improve the assembly precision of the limit structure and prevent the problem of interference between the light guide plate and the light source and other components from occurring upon assembly, and also ensure the limiting performance of the limit structure on the light guide plate, preventing the movement of the light guide plate to collide with the light guide plate to produce abnormal noise and other undesirable.

In some embodiments, based on the integrally formed frame 50 and limit structure 40, the length of the connection portion 421 in the embodiments of the present disclosure in the extension direction is equal to the length of the frame 50. That is, with the limit structure 40 shown in FIG. 9 as a portion of the frame 50, with this structural arrangement, the frame 50 is a double bearing structure, which can improve the overall strength of the frame 50 and avoid deformation of the frame 50.

Technicians in the field should design the integration between the limit structure 40, the frame 50, and the back plate 10 based on the actual structure of the backlight source, and select the options of the integrally forming the limit structure 40 and the frame 50, integrally forming the limit structure 40 and the back plate 10, and integrally forming the structure of the connection portion 421 based on the actual application, which is not repeated herein.

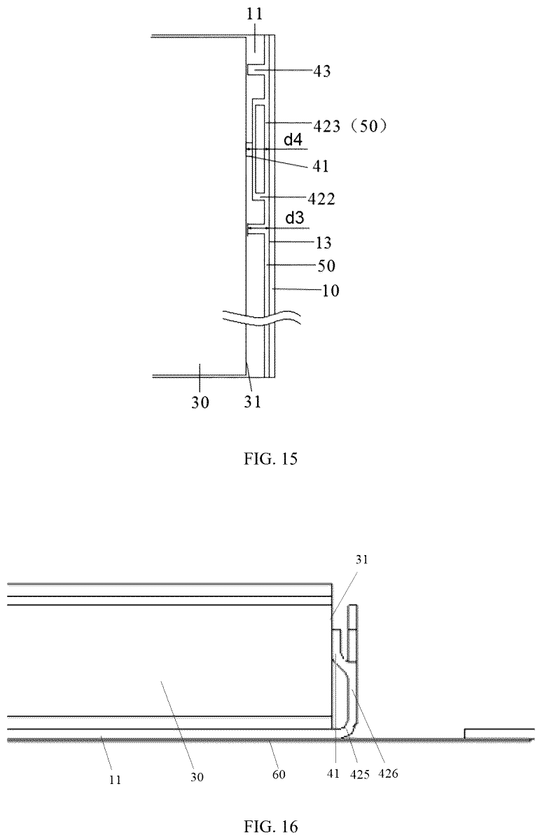

In another embodiment of the present disclosure, as shown in FIG. 15, the backlight source further includes a frame 50 clamped with the back plate 10, the frame 50 being disposed on sides, close to the light guide plate 30, of the first sidewall 12 and the second sidewall 13. The backlight source in the embodiments is an internal clamped structure, i.e., in the case that the frame 50 and the back plate 10 are assembled, the frame 50 is disposed on the inner side of the second sidewall 13 of the back plate 10.

In the internal clamped structure of the frame 50 and the back plate 10, as shown in FIG. 15, the limit structure 40 and the frame 50 are integrally formed. In this way, the carrier portion 423 and the second support portion 43 are both portions of the sidewall of the frame 50 close to the light guide plate 30. This integrally structure can avoid the assembly of the limit structure, thereby improving the assembly efficiency. Moreover, in the embodiments of the present disclosure, the frame and the back plate are fixed, which can improve the assembly precision of the limit structure, prevent the problem of interference between the light guide plate and the light source and other components upon assembly, and also ensure the limiting performance of the limit structure on the light guide plate to prevent the light guide plate from moving and colliding to produce abnormal noise and other malpractices.

In another optional embodiment, as shown in FIG. 15, the limit structure 40 further includes a second support portion 43, the orthographic projection of the second support portion 43 on the first surface being disposed on both sides of the orthographic projection of the deformation portion 42 on the first surface. Exemplarily, as shown in FIG. 15, the orthographic projection of the second support portion 43 on the first surface is axisymmetric with the orthographic projection of the abutment portion 41 on the first surface as an axis of symmetry, i.e., the second support portion 43 is symmetrically arranged about the axis of symmetry of the connection portion 421, which results in a more balanced support performance.

The second support portion 43 is disposed between the second sidewall 13 and the third sidewall 31 and is connected to the second sidewall 13. In the embodiments, the second support portion 43 is connected to the frame 50, and the frame 50 is clamped with the back plate, thereby indirectly connecting the second support portion 43 to the second sidewall 13.

In the embodiments, the second support portion 43 includes a convex structure extending in a direction from the second sidewall 13 to the third sidewall 31, and a distance d3 of a surface of the second support portion 43 close to the third sidewall 31 from the third sidewall 31 is less than a distance d4 of the abutment surface 411 from the third sidewall 31. Utilizing the second support portion 43, on the one hand, it is possible to ensure the assembly performance of the frame 50 and the backboard 10 and avoid the frame warps, on the other hand, the second support portion 43 is a non-deformable structure, which enables the second support portion 43 to provide limiting support to the light guide plate 30 in the case that the deformation of the deformation portion 42 produces a deformation and the light guide plate 30 is abutted against the light guide plate 30, and the combination of the non-deformable solid support of the second support portion 43 and the elastic support of the deformation of the deformation portion 42 further improves the limiting effect on the light guide plate 30.

In the embodiments, the second support portion 43 can also be applied in the scheme of integrally forming the back plate 10 and the limit structure 40, i.e., the second support portion 43 is disposed on the second sidewall 13 of the back plate 10, and the orthographic projection of the second support portion 43 on the second sidewall 13 is disposed on the outer side of the connection portion 421. Exemplarily, the second support portion 43 is a convex structure extending from the second sidewall 13 towards the third sidewall 31, which second support portion 43 is a portion of the back plate 10, and which second support portion 43 is utilized to provide limit protection for the light guide plate 30.

As shown in FIG. 14, in the external clamped structure, the limit structure 40 and the frame 50 are integrally formed, at which time, the carrier portion 423 and the second support portion 43 are both part of the sidewall of the frame 50 close to the side of the light guide plate 30. This integrated arrangement can likewise avoid the assembly of the limit structure, thereby improving the assembly efficiency. Moreover, in the embodiments of the present disclosure, the matching of the frame and the back plate can improve the assembly precision of the limit structure and prevent the problem of interference between the light guide plate and the light source and other components from occurring upon assembly. In this way, the non-deformed solid support of the second support portion 43 and the deformed elastic support of the deformation portion 42 are combined to further improve the limiting effect on the light guide plate 30, and prevent the light guide plate from moving and colliding to produce abnormal noise and other malpractices.

In another example, in the integrated external clamped structure, the structure of the first support portion 422 has a symmetrical structural of multiple support pillars as shown in FIG. 5. In another example, in the integrated external clamped structure, the through-hole in the limit structure 40 has the structural of different shapes of the embodiments shown in the preceding FIGS. 6 to 9. That is, in the embodiments of the present disclosure, scheme for the integration of the limit structure 40 and the frame 50 in the external clamped assembly, the structural of the relevant places can be combined with reference to the aforementioned embodiments, and any relevant scheme obtained under this structure in combination with the aforementioned embodiments is within the scope of protection of the present disclosure.

In some embodiments, as shown in FIG. 15, in the integrated internal clamped structure, the orthographic projection of the connection portion 421 on the second sidewall 13 is overlapped with the orthographic projection of the carrier portion 423 on the second sidewall 13, i.e., the same lengths of the connection portion 421 and the carrier portion 423 in the embodiments of the present disclosure are equal, and the structure of the connection portion 421 in the embodiments is simple to avoid that the material of the connection portion 421 is detached and enters into the display area, resulting in an abnormal occurrence of poor display.

In another example, in the integrated internal clamped structure, the structure of the connection portion 421 has a scheme as shown in FIG. 8, e.g., the connection portions 421 of the plurality of limit structures 40 are connected sequentially to form a connection portion 421 with an overall length equal to the frame length.

In another example, in the integrated internal clamped structure, the structure of the first support portion 422 has a symmetrical structural of multiple support posts as shown in FIG. 5. In another example, in the internal clamped structure, the through-hole in the limit structure 40 has the structural of different shapes of the embodiments shown in the preceding FIGS. 6 to 9. That is, the scheme of integrating the limit structure 40 and the frame 50 in the internal clamped structure in the embodiments of the present disclosure, and the structural of the relevant places can be combined with reference to the aforementioned embodiments, and any relevant scheme obtained by combining with the aforementioned embodiments under this structure is within the scope of protection of the present disclosure.

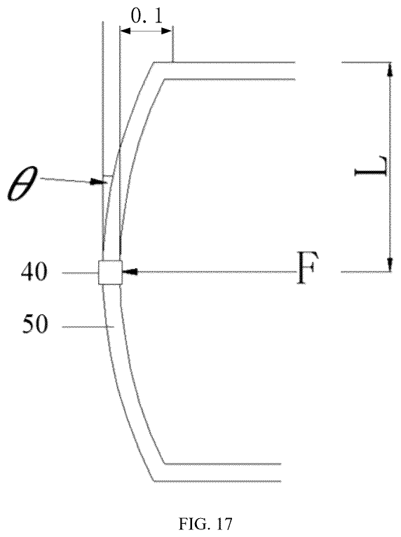

In another embodiment of the present disclosure, as shown in FIG. 16, the limit structure 40 is integrated with the back plate 10. Both the abutment portion 41 and the deformation portion 42 are formed by bending a portion of the back plate. The deformation portion 42 includes a bending portion 425 and a fixing portion 426. The bending portion 425 is disposed on the side, close to the light guide plate 30, of the bottom plate 11, and is bent from the bottom plate 11 toward the third sidewall 31, and the bending portion 425 is disposed at a position corresponding to an orthographic projection of the third sidewall 31 on the first surface of the bottom plate 11. The fixing portion 426 is connected to the bent portion 425 and is parallel to the third sidewall 31, and an end portion of the fixing portion 426 on the side away from the bent portion 425 is disconnected from the bottom plate 11. The abutment portion 41 is connected to the fixing portion 426 and is disposed on the side, close to the light guide plate 30, of the fixing portion 426. The bending portion 425 bends from the bottom plate 11 toward the third sidewall 31, driving the fixing portion 426 to move from the bottom plate 11 toward the third sidewall 31, such that the abutment portion 41 is fixed against the third sidewall 31.

The limit structure 40 in the embodiments is different from the limit structure 40 in the embodiments of FIGS. 2 to 15. The limit structure 40 in the embodiments is integrated with the back plate 10. In the embodiments, in the case that the limit structure 40 is in the unbent state, the bent portion 425, the fixing portion 426, and the back plate 11 are in the same plane. The end portion of the fixing portion 426 on the side away from the bending portion 425 is disconnected from the back plate 11, and the disconnection arrangement facilitates bending the bending portion 425, which is disposed at a position corresponding to an orthographic projection of the third sidewall 31 on the first surface of the back plate 11, such that the abutment portion 41 is able to form a abutment force with the light guide plate 30 upon bending to achieve the limiting effect of the light guide plate 30. In one example, the bent portion 425 and the fixing portion 426 are formed directly while manufacturing the back plate 10.

Further, bending the bending portion 425 and the fixing portion 426, which are in the same plane, causes the bending portion 425 to perform a bending deformation toward the third sidewall 31, which further drives the fixing portion 426 to rotate from the backboard 11 toward the third sidewall 31, causing the fixing portion 426 to rotate to the corresponding position of the third sidewall 31. In the case that the light guide plate 30 and the back plate 10 are assembled, the abutment portion 41 disposed on the surface, close to the light guide plate 30, of the fixing portion 426 is fixed against the third sidewall 31 of the light guide plate 30, thereby limit the light guide plate 30.

The limit structure 40 of the embodiments is integrally formed with the back plate 10, eliminating the limit member shown in FIG. 1, which can effectively prevent poor assembly and substantially improve the assembly efficiency, and the limit structure 40 can effectively reduce the production cost of the backlight source.

In some embodiments, as shown in FIG. 16, the limit structure 40 and the first surface of the back plate 10 of the embodiments are integrally formed, and the end portion of the fixing portion 426 and the first surface are disconnected. The disconnection of the first surface leads to light leakage, and therefore, in order to avoid that this arrangement has an effect on the performance of the backlight source, the backlight source also includes a shading portion 60 disposed on a surface on the side of the first surface away from the light guide plate 30. The orthographic projection of the shading portion 60 on the first surface covers the orthographic projection of the fixing portion 426 on the first surface in the case that the fixing portion 426 is not bent, and this arrangement is capable of shading the break between the fixing portion 426 and the first surface to prevent light leakage. This arrangement is capable of shielding the fixing portion 426 and the first surface, preventing light leakage, and further ensuring display performance.

As shown in FIG. 10, a plurality of limit structures 40 are arranged at the third sidewall 31 of the light guide plate 30, and the plurality of limit structures 40 are disposed on the same sub-sidewall of the back plate 10 and at the third sidewall 31 opposite to the sub-sidewall. Because the size of the backlight source is different, the quantity of limit structures 40 disposed at different sub-sidewalls are different, and the quantity of limit structures 40 is arranged in the embodiments of the present disclosure.

In some embodiments, the quantity N of limit structures attached to any sub-sidewall satisfies the following relationship:

$$\frac{A}{N + 1} \leq L \leq \frac{A}{N} .$$

As shown in FIG. 10, wherein L represents the minimum distance from the limit structure 40 to which the sub-sidewall is connected to an end of the sub-sidewall, and A is the length of the sub-sidewall.

In one example, taking the integration of the frame 50 and the limit structure 40 being integrally formed as an example, i.e., as shown in FIG. 14, the limit structure 40 is applied to a sidewall of the frame 50 toward the side of the third sidewall 31. The length of the light guide plate 30 is X, the expansion rate of the light guide plate 30 is preset to be 0.003, the deformation amount of each limit structure 40 is 0.003×, and according to Hooke's law, the abutment force F provided by the limit structure 40 being abutting against the light guide plate 30 is:

$$F = 0.003 E \frac{S}{R} X ,$$

wherein S represents the cross-sectional area of the frame, R represents the thickness of the frame, and E represents the modulus of elasticity of the material applied to the frame.

The force analysis of the frame 50 at the position of the limit structure 40 is carried out, as shown in FIG. 17, and the maximum deformation amount of the whole frame is disposed to be 0.1 (arranged based on the space between the frame 50 and the back plate 10 in practical applications, and the space between the frame 50 and the back plate 10 in the example is 0.1), and thus the deformation angle θ of the frame≈0.1, wherein the deformation angle θ is the angle formed by the deformed surface of the frame and the tangent line of the deformed surface of the frame.

Let the minimum distance from the limit structure 40 to the end of the sub-sidewall be L. The bending moment M of the frame is calculated as:

$$M = FL = \frac{θ EI}{L} ,$$

wherein the frame has a cross-sectional moment of inertia

$$I = \frac{{HR}^{3}}{12} ,$$

wherein H represents the height of the frame cross-section and R represents the thickness of the frame;

$$M = 0.0 \; 03 E \frac{S}{R} XL = \frac{0.1 {ERH}^{3}}{12 L} ;$$

A minimum distance

$$L = \frac{5}{3} H \sqrt{\frac{R}{X}}$$

is obtained from the limit structure 40 to the end of this sidewall.

The total length of the frame is A, the quantity of limit structures at this second sidewall is N, and the relationship between the length of the frame and the quantity of limit structures is determined as

$$\frac{A}{N + 1} \leq L \leq \frac{A}{N} .$$

The embodiments enable the backlight source to take into account both the limiting performance and the assembling performance by establishing the correspondence between the quantity of limit structures and the length of the sidewall of the frame.

Exemplarily, the plurality of limit structures in the embodiments of the present disclosure are uniformly distributed at a second sidewall, such that the force on the light guide plate is balanced, ensuring that the light guide plate can be fixed and prevented from being deflected.

In some embodiments, the limit structure 40 is not disposed at 15 mm to 20 mm from the end of the first sub-sidewall 131, from the end of the second sub-sidewall 132, or from the end of the third sub-sidewall 133. In the embodiments, the minimum distance L from the limit structure 40 to the end of this sidewall ranges from 15 mm to 20 mm, i.e., the limit structure 40 in the embodiments of the present disclosure is not provided at the apex of the light guide plate 30 edge of the light guide plate 30.

Unlike the manner in FIG. 1 in which the light guide plate 30 is limited at the top corner edge and the top corner edge of the back plate 10 utilizing the limit member to avoid the phenomenon of the light guide plate rotating due to the torque action in the case that the limit structure 40 is deformed, this arrangement is capable of further preventing the light guide plate from rotating on top of the limit of the light guide plate 30.

Unlike the previous embodiment, in the embodiment of the present disclosure, another distribution method is provided to arrange the position of the limit structure 40. In another optional embodiment, the plurality of limit structures 40 are evenly distributed at a second sidewall. In the case that the first concentrated load maximum deflection Y_{1 MAX} is greater than or equal to a predetermined shedding threshold, i.e., Y_{1 MAX}≥T, the quantity of limit structures is greater than three. In the case that the second concentrated load maximum deflection Y_{2 MAX} is greater than or equal to the predetermined dislodgement threshold, and the first concentrated load maximum deflection Y_{1 MAX} is less than or equal to the predetermined dislodgement threshold, i.e., Y_{2MAX}≥T≥Y_{1 MAX}, then the quantity of limit structures is three. In the case that the second concentrated load maximum deflection Y_{2 MAX} is less than or equal to the predetermined shedding threshold, i.e., Y_{2 MAX}≤T, the quantity of limit structures is two.

In one example, the integration of the frame 50 and the limit structure 40 is taken as an example, i.e., as shown in FIG. 14, the limit structure 40 is applied to the sidewall of the frame 50 toward the side of the third sidewall 31 as an example. The length of the light guide plate 30 is X, the expansion rate of the light guide plate 30 is preset to be 0.003, the deformation amount of each limit structure 40 is 0.003×, and according to Hooke's law, the abutment force F provided by the limit structure 40 being abutting against the light guide plate 30 is:

$$F = 0.003 \frac{ES}{R} X ,$$

wherein E represents the modulus of elasticity of the material applied to the frame, R represents the thickness of the frame, and S represents the cross-sectional area of the frame.

According to the deflection formula, the maximum deflection of the frame for the first concentrated load when three limit structures are arranged at equal spacing is:

$${Y}_{1 MAX} = \frac{6.33 {FL}_{1}^{3}}{384 EI} ;$$

### Wherein,

$${L}_{1} = \frac{1}{4} L ,$$

I represents the cross-section moment of inertia of the frame,

$$I = \frac{{RH}^{3}}{12} ,$$

H represents the cross-section height of the frame, and R represents the thickness of the frame.

Considering that a fitting space is present in the case that the frame 50 is assembled with the back plate 10, in the embodiments of the present disclosure, the fitting space (Overlap typ) is determined as a preset dislodgement threshold T. Exemplarily, the fitting space is 0.5 mm. That is, there is a risk that the frame is to be dislodged when the maximum deflection of the first centralized load Y_{1 MAX}≥0.5 mm, and therefore a limit structure of more than 3 needs to be set up for this case.

In the case that Y_{1MAX}≤0.5 mm, the quantity of limit structures to be set is further determined.

According to the deflection calculation formula, when two limit structures are arranged at equal spacing, the maximum deflection of the second concentrated load of the frame is

$${Y}_{2 MAX} = \frac{6.81 {FL}_{2}^{3}}{384 EI} ; {whereinL}_{1} = \frac{1}{3} {L}_{∘}$$

In the case that Y_{2 MAX}≥MAX and Y_{1 MAX}<MAX, three limit structures are disposed on one sidewall (i.e., one sub-sidewall);

In the case that Y_{2 MAX}≤MAX, two limit structures are disposed on one sidewall.

By establishing a correspondence between the quantity of limit structures 40 and the length of the sidewalls of the frame 50, the embodiments also take into account the risk of the frame falling off, further improving the overall performance of the backlight source.

In another optional embodiment, the spacing distance between adjacent limit structures 40 disposed on the same sub-sidewall ranges from 50 to 70 mm. That is, unlike the manner shown in FIG. 1 of utilizing the limit member 70 for limiting at the top corner edge of the light guide plate 30 and at the top corner edge of the back plate 10, the limit structures 40 in the embodiments of the present disclosure are not provided at the top corner edge of the backlight source, but are provided at the respective The limit structure 40 in the embodiments is not disposed at the top corner edge of the backlight source, but is instead disposed at the outside of each edge of the light guide plate 30, to avoid the phenomenon of the light guide plate rotating due to the torque effect when the limit structure 40 undergoes deformation, and the arrangement is capable of limiting the light guide plate 30 based on the limiting of the light guide plate 30 and further preventing the rotation of the light guide plate 30.

In some embodiments, as shown in FIG. 10, the end portion, close to the light source 20, of the light guide plate 30 is a protrusive corner 30a that cooperates with the end portion of the light source 20. In the embodiments, the light guide plate 30 is limited and fixed by the limit structure 40 according to the above embodiments, and further, the positioning of the side of the light source 20 is achieved by the protrusive corner that cooperates with the light source 20 and facilitates the assembly of the light guide plate 30, thereby improving the assembly efficiency. assembly, thereby improving the assembly efficiency.

In another optional embodiment, as shown in FIG. 10, the light source 20 is also disposed on the second sub-sidewall 132 or the third sub-sidewall 133 adjacent to the first sidewall 11. As shown in FIG. 2, the light source in the embodiment of the present disclosure of the L-type and is disposed on the first sidewall 11 and the third sub-sidewall 133, and the light guide plate 30 and the light source disposed on each of the sidewalls are provided as a matching cambered angle structure to efficiently limit the light guide plate.

Based on the above exemplary description of the backlight source of the embodiments of the present disclosure, the backlight source of the embodiments of the present disclosure eliminates the limit member in the conventional backlight source, which effectively prevents poor assembly and substantially improves the assembly efficiency and reduces the cost. Moreover, the limit structure 40 in the embodiment is disposed between the sidewall of the light guide plate 30 and the sidewall of the backplane 10, and the limit structure 40 and the light guide plate 30 are utilized to be abutted to fix the light guide plate 30, and the limit structure 40 in the embodiment is capable of being deformed under high temperature or vibration conditions, such that the light guide plate 30 can be limited in various states, which effectively prevents the backlight source from vibration and rattling, deflection of the light guide plate 30 and other defects, and has a wide range of application prospects.

The present disclosure embodiment also proposes a display device including the above backlight source and a display panel, which is disposed on the light-out surface of the light guide plate.

The display device of the embodiments of the present disclosure is any product or component that requires a backlight source, such as a cell phone, a tablet computer, a television, a monitor, a laptop computer, a digital photo frame, a vehicle display device, and an ink screen, and the embodiments of the present disclosure are not limited thereto.

It is to be noted that in the description of the present disclosure, relational terms such as first and second are used only to distinguish one entity or operation from another, and do not necessarily require or imply the existence of any such actual relationship or order between these entities or operations. Furthermore, the terms “including,”, “containing,” and any other variants thereof are intended to cover non-exclusive encompassing, such that a process, method, article or apparatus including a set of elements includes not only those elements, but also other elements not expressly listed, or also includes elements that are inherent to such process, method, article, or apparatus. Without further limitation, the fact that an element is defined by the phrase “including a . . . ” does not exclude the existence of another identical element in the process, method, article, or apparatus including the said element.

Obviously, the above embodiments of the present disclosure are only examples for the purpose of clearly explaining the present disclosure, and are not a limitation of the embodiments of the present disclosure, for those of ordinary skill in the field, on the basis of the above description, other different forms of changes or variations can also be made, and it is not possible herein to exhaust all the embodiments, and all the variations or variations that belong to the technical scheme of the present disclosure are still under the protection of the present disclosure, and the obvious variations or variations are still under the protection of the present disclosure. All obvious changes or variations derived from the technical solutions of the present disclosure are still within the scope of protection of the present disclosure.

1. A backlight source, comprising:
a back plate, comprising a bottom plate, a first sidewall perpendicular to a first surface of the bottom plate and connected to the bottom plate, and a plurality of second sidewalls perpendicular to the first surface and connected to the bottom plate;
a light guide plate, disposed on the first surface, wherein the light guide plate comprises third sidewalls opposite to and parallel to the plurality of second sidewalls;
a light source, disposed on the first surface, wherein at least a portion of the light source is disposed between the first sidewall and the light guide plate; and
a plurality of limit structures, configured to secure the light guide plate, wherein the limit structure is disposed on a side, close to the second sidewall opposite to the third sidewall, of the third sidewall and is abutted against the third sidewall, and the limit structure is connected to the second sidewall opposite to the third sidewall with which the limit structure is contacted.

2. The backlight source according to claim 1, wherein the limit structure comprises:
an abutment portion, attached to the third sidewall; and
a deformation portion, connected to the abutment portion, and configured to be deformed to cause the abutment portion to be abutted against the third sidewall.

3. The backlight source according to claim 2, wherein the deformation portion comprises:
a connection portion, connected to the abutment portion, wherein an orthographic projection of the connection portion on the first surface is axisymmetric about an orthographic projection of the abutment portion on the first surface as an axis of symmetry;
a first support portion, disposed on a side, away from the abutment portion, of the connection portion and connected to the connection portion; and
a carrier portion, disposed on a side, away from the connection portion, of the first support portion and connected to the support portion;
wherein the connection portion, the first support portion, and the carrier portion form a through-hole structure.

4. The backlight source according to claim 3, wherein the connection portion has an axisymmetric structure, an axis of symmetry of the connection portion is perpendicular to a length direction of the connection portion, and the deformation portion satisfies at least one of the following conditions:
the abutment portion is symmetrically arranged about the axis of symmetric of the connection portion;
the first support portion is symmetrically arranged about the axis of symmetry of the connection portion; and
the through-hole structure is symmetrically arranged about the axis of symmetric of the connection portion.

5. The backlight source according to claim 4, wherein the through-hole structure comprises a first through-hole edge close to the connection portion and a second through-hole edge close to the carrier portion, the first through-hole edge and the second through-hole edge forming a closed pattern; and
a minimum distance between the first through-hole edge and a surface, close to the third sidewall, of the connection portion is less than or equal to a minimum distance between the second through-hole edge and a secured surface of the carrier portion secured to the second sidewall.

6. The backlight source according to claim 4, wherein the through-hole structure comprises a first through-hole edge close to the connection portion and a second through-hole edge close to the carrier portion, the first through-hole edge and the second through-hole edge forming a closed pattern;
wherein the closed pattern comprises a first angle close to the connection portion and a second angle close to the carrier portion side, the first angle being less than or equal to the second angle.

7. The backlight source according to claim 4, wherein an orthographic projection of the connection portion on the third sidewall encloses an orthographic projection of the carrier portion on the third sidewall.

8. The backlight source according to claim 2, wherein
the abutment portion comprises at least one protrusion structure, wherein the protrusion structure comprises a protrusion surface projecting toward the third sidewall, and the protrusion surface comprises:
an abutment surface, parallel to the second sidewall or the third sidewall, the abutment surface being abutted against the third sidewall; and
a connection surface, disposed on a side, close to the first surface, of the abutment surface and connected to the abutment surface, the connection surface being beveled or curved.

9. The backlight source according to claim 8, wherein the limit structure further comprises a second support portion, an orthographic projection of the second support portion on the first surface is disposed on either side of an orthographic projection of the deformation portion on the first surface; and
the second support portion is disposed between the second sidewall and the third sidewall and is connected to the second sidewall, and a distance between a surface, close to the third sidewall, of the second support portion and the third sidewall is less than a distance between the abutment surface and the third sidewall.

10. The backlight source according to claim 1, wherein
the second sidewall comprises a first sub-sidewall opposite to the first sidewall, a second sub-sidewall and a third sub-sidewall adjacent to the first sidewall, wherein the second sub-sidewall, the first sub-sidewall, the third sub-sidewall and the first sidewall are connected sequentially;
wherein the limit structure is disposed at least on one of the first sub-sidewall, the second sub-sidewall, and the third sub-sidewall.

11. The backlight source according to claim 10, wherein a quantity N of the limit structures connected to one of the first sub-sidewall, the second sub-sidewall and the third sub-sidewall satisfies a following relationship:
$$\frac{A}{N + 1} \leq L \leq \frac{A}{N} ;$$
wherein L represents a minimum distance between the limit structure connected to the sub-sidewall and an end of the sub-sidewall, A represents a length of the sub-sidewall, and the N limit structures are equally spaced along an extension direction of the sub-sidewall where the N limit structure are disposed.

12. The backlight source according to claim 10, further comprising a frame clamped with the back plate, the frame is disposed on sides, close to the light guide plate, of the first sidewall and the second sidewall, and the limit structure and the frame are integrally formed;
a quantity N of the limit structures connected to one of the first sub-sidewall, the second sub-sidewall, and the third sub-sidewall satisfies a following relationship:
N is greater than three in the case that a first concentrated load maximum deflection is greater than or equal to a predetermined separating threshold;
N equals three in the case that a second concentrated load maximum deflection is greater than or equal to the predetermined separating threshold and the first concentrated load maximum deflection is less than the predetermined separating threshold; or
N equals two in the case that to the second concentrated load maximum deflection is less than or equal to the predetermined separating threshold;
wherein the first concentrated load maximum deflection is a maximum deflection of the frame in the case that three limit structures are equally spaced on the sub-sidewall, and the second concentrated load maximum deflection is a maximum deflection of the frame in the case that two limit structures are equally spaced on the sub-sidewall; and
the N limit structures are equally spaced along an extension direction of the sub-sidewall where the N limit structure are disposed.

13. The backlight source according to claim 10, wherein a minimum distance between the limit structures and an end of the second sidewall connected to the limit structure ranges from 15 mm to 20 mm.

14. The backlight source according to claim 10, wherein a distance between two adjacent limit structures disposed on one second sidewall ranges from 50 mm to 70 mm.

15. The backlight source according to claim 1, wherein the limit structure is disposed between the third sidewall and the second sidewall opposite to the third sidewall.

16. The backlight source according to claim 3, wherein a groove configured to be engaged with the first support portion is disposed in the second sidewall, the first support portion is disposed in the groove, and an orthographic projection of the connection portion on the second sidewall encloses an orthographic projection of the groove on the second sidewall.

17. The backlight source according to claim 16, further comprising a frame clamped with the back plate; wherein
the frame is disposed on sides, away from the light guide plate, of the first sidewall and the second sidewall; and
the limit structure is in contact with the frame, or the limit structure and the frame are integrally formed.

18. The backlight source according to claim 1, further comprising a frame clamped with the back plate; wherein
the frame is disposed on sides, close to the light guide plate, of the first sidewall and the second sidewall; and
the limit structure and the frame are integrally formed.

19. The backlight source according to claim 2, wherein
the limit structure and the back plate are integrally formed, the deformation portion and the abutment portion are formed by bending portions of the back plate, and the deformation portion comprises a bending portion and a fixing portion; wherein
the bending portion is bent from the back plate towards the third sidewall, and the bending portion is disposed at a position corresponding to an orthographic projection of the third sidewall on the first surface;
the fixing portion is connected to the bending portion and is parallel to the third sidewall; and
the abutment portion is connected to the fixing portion and is disposed on a side, close to the light guide plate, of the fixing portion.

20-21. (canceled)

22. A display device, comprising a display panel and a backlight source, wherein the backlight source comprises:
a back plate, comprising a bottom plate, a first sidewall perpendicular to a first surface of the bottom plate and connected to the bottom plate, and a plurality of second sidewalls perpendicular to the first surface and connected to the bottom plate;
a light guide plate, disposed on the first surface, wherein the light guide plate comprises third sidewalls opposite to and parallel to the plurality of second sidewalls;
a light source, disposed on the first surface, wherein at least a portion of the light source is disposed between the first sidewall and the light guide plate; and
a plurality of limit structures, configured to secure the light guide plate, wherein the limit structure is disposed on a side, close to the second sidewall opposite to the third sidewall, of the third sidewall and is abutted against the third sidewall, and the limit structure is connected to the second sidewall opposite to the third sidewall with which the limit structure is contacted; and
the display panel is disposed on a light-emitting side of the light guide plate.
